(19) United States
(12) Patent Application Publication
(10) Pub. No.: US 2014/0052522 A1
(43) Pub. Date: Feb. 20, 2014

(54) Promotion Management Systems and Methods

(71) Applicant: StepsAway, Inc., North Hollywood, CA (US)

(72) Inventors: Boman B. Irani, La Honda, CA (US); Bruce Lyon, Santa Barbara, CA (US); Allan Haims, Sherman Oaks, CA (US); J.D. Trout, San Francisco, CA (US)

(21) Appl. No.: 13/962,834

(22) Filed: Aug. 8, 2013

Related U.S. Application Data
(60) Provisional application No. 61/681,103, filed on Aug. 8, 2012.

(51) Int. Cl. G06Q 30/02

(52) U.S. Cl. CPC G06Q 30/0225; G06Q 30/0261
USPC 705/14.26

(57) ABSTRACT

A request may be received from a customer device to access a local area network, the local area network accessible via one or more network access points in a geographic location. A network entry page may be provided to the customer device in response to the request, the network entry page providing a portal to a set of promotions offered by a set of merchants, the set of promotions redeemable by a user of the customer device, the set of merchants being in the geographic location. A selection may be received by the user of a particular promotion from the set of promotions. A promotion code associated with the particular promotion may be provided to the customer device. The promotion code may enable redemption of the particular promotion from a particular merchant.

### CLAIM OF PRIORITY

The present application claims priority to provisional U.S. Patent Application No. 61/681,103, entitled “Coupon Management System,” filed Aug. 8, 2012, the contents of which are hereby incorporated by reference herein.

### TECHNICAL FIELD

The technical field relates to computer systems and methods. More particularly, the technical field relates to computer systems and methods for efficiently delivering electronic promotions.

### BACKGROUND

Despite the growth of electronic commerce, customers still enjoy visiting malls. Malls provide a diverse array of stores at a common physical location. The stores at a mall may offer different things to different people. To a focused customer who knows what she wants, a mall may provide convenient access to items of interest. To a casual customer, a mall may provide the ability to browse products. To a customer who is not interested in buying anything at all, a mall may provide a walkable and social environment.

To merchants, malls may provide many opportunities. For example, malls may provide merchants with the opportunity to convert foot traffic into actual purchases. That is, casual customers or customers not interested in buying anything at all may nonetheless wander into a store and fall in love with an item they can touch and feel. Even focused customers, while trying to find the items they are looking for, may encounter and want to purchase other items they did not know existed.

Attempts to provide paper or email coupons may not work well at malls. For one thing, there may be a large number of merchants at a mall. A customer would have to carry many coupons, one for each merchant. Such a load on a customer's pocket or email box may be too cumbersome. For another thing, the paper or email coupons would be provided to customers in advance of when the customers entered the mall. As a result, the customers who would typically use such coupons would be those who planned their purchases in advance. Those customers may not be likely to buy something on impulse.

### SUMMARY

In a method, a request may be received from a customer device to access a local area network, the local area network accessible via one or more network access points in a geographic location. A network entry page may be provided to the customer device in response to the request, the network entry page providing a portal to a set of promotions offered by a set of merchants, the set of promotions redeemable by a user of the customer device, the set of merchants being in the geographic location. A selection may be received by the user of a particular promotion from the set of promotions. A promotion code associated with the particular promotion may be provided to the customer device. The promotion code may enable redemption of the particular promotion from a particular merchant.

In some embodiments, the particular merchant may be located within the coverage of the local area network. The particular promotion may comprise a timer configured to expire the particular promotion.

In various embodiments, the promotion code may comprise an alphanumeric code or an image. The promotion code may comprise a barcode or a Quick Response (QR) code. Further, enabling the redemption of the promotion code may comprise machine reading the promotion code. The method may comprise monitoring whether the particular promotion was redeemed. Analytics related to the particular promotion may be provided. Analytics related to the customer device may be provided.

In various embodiments, the local area network may comprise an 802.11 wireless network. The request to access the local area network may be received in response to the customer device attempting to switch from another data network. The other data network may comprise a Third Generation (3G) or a Fourth Generation (4G) data network.

In some embodiments, the network entry page may be rendered on a web browser on the customer device. The network entry page may comprise a home page of a mobile application on the customer device.

In a system, a network monitoring module may be operative to receive a request from a customer device to access a local area network, the local area network accessible via one or more network access points in a geographic location. A network entry page module may be operative to provide a network entry page to the customer device in response to the request, the network entry page providing a portal to a set of promotions offered by a set of merchants, the set of promotions being redeemable by a user of the customer device, the set of merchants being in the geographic location. A promotion control module may be operative to: receive, a selection by the user of a particular promotion from the set of promotions, and provide to the customer device a promotion code associated with the particular promotion, the promotion code enabling redemption of the particular promotion from a particular merchant.

In some embodiments, the particular promotion may comprise a timer configured to expire the particular promotion. A promotion search module may be operative to facilitate a search of the set of promotions. A promotion sharing module may be operative to facilitate sharing of the set of promotions. A customer profile management module may be operative to manage a customer profile of the customer device.

A system may comprise means for receiving a request from a customer device to access a local area network, the local area network accessible via one or more network access points in a geographic location. The system may comprise means for providing a network entry page to the customer device in response to the request, the network entry page providing a portal to a set of promotions offered by a set of merchants, the set of promotions being redeemable by a user of the customer device, the set of merchants being in the geographic location. The system may further include means for receiving a selection by the user of a particular promotion from the set of promotions, and for providing to the customer device a promotion code associated with the particular promotion, the promotion code enabling redemption of the particular promotion from a particular merchant.

Other features and embodiments are apparent from the accompanying drawings and from the following detailed description.

### BRIEF DESCRIPTION OF THE DRAWINGS

FIG. 1 depicts an exemplary promotion distribution environment, according to some embodiments.

FIG. 2 depicts a flowchart of an exemplary method for distributing promotions, according to some embodiments.

FIG. 3 depicts an exemplary promotion management system, according to some embodiments.

FIG. 4 depicts a flowchart of an exemplary method for managing promotions, according to some embodiments.

FIG. 5 depicts an exemplary promotion management controller, according to some embodiments.

FIG. 6 depicts a flowchart of an exemplary method for providing promotions, according to some embodiments.

FIG. 7 depicts an exemplary digital device, according to some embodiments.

FIG. 8 depicts a welcome screen of an exemplary promotion management application, according to some embodiments.

FIG. 9 depicts a pending offers screen of an exemplary promotion management application, according to some embodiments.

FIG. 10 depicts a promotion image upload screen of an exemplary promotion management application, according to some embodiments.

FIG. 11 depicts a preview screen of an exemplary customer application, according to some embodiments.

FIG. 12 depicts a deployment screen of an exemplary customer application, according to some embodiments.

FIG. 13 depicts a network entry screen of an exemplary customer application, according to some embodiments.

FIG. 14 depicts a promotions screen of an exemplary customer application, according to some embodiments.

FIG. 15 depicts a promotions screen of an exemplary customer application, according to some embodiments.

FIG. 16 depicts a department screen of an exemplary customer application, according to some embodiments.

FIG. 17 depicts a merchant screen of an exemplary customer application, according to some embodiments.

FIG. 18 depicts a particular merchant screen of an exemplary customer application, according to some embodiments.

FIG. 19 depicts another particular merchant screen of an exemplary customer application, according to some embodiments.

FIG. 20 depicts a selected promotion screen of an exemplary customer application, according to some embodiments.

### DETAILED DESCRIPTION

In various embodiments, there lies the insight that customers may wish to switch their devices from a cellular network to a lower-cost wireless network associated with a geographic location when they enter the geographic location. In a sense, the wireless network may function as a pinch-point for information presentation. There also lies the insight that consumers may be more willing to redeem promotions at merchants in a geographic location if the consumers are already in the geographic location. Together, these insights may help merchants convert foot traffic into real purchases.

A promotion distribution environment may allow merchants to create and rapidly deploy promotions to customers at a facility. Merchants may access a promotion management application to create promotions they believe to be relevant to their business. The merchants may base the promotions on price and inventory details that the merchants need not share with third parties, such as advertisers, media companies, or other merchants. Once the promotions have been created, a promotion management system may push the promotions to a promotion management controller. The promotion management controller may control a network access point for the facility. Each time a customer's device attempts to connect to the network, the customer device may pull the promotions to it. The resulting system is a merchant-driven and localized set of promotions that are likely to be converted to purchases.

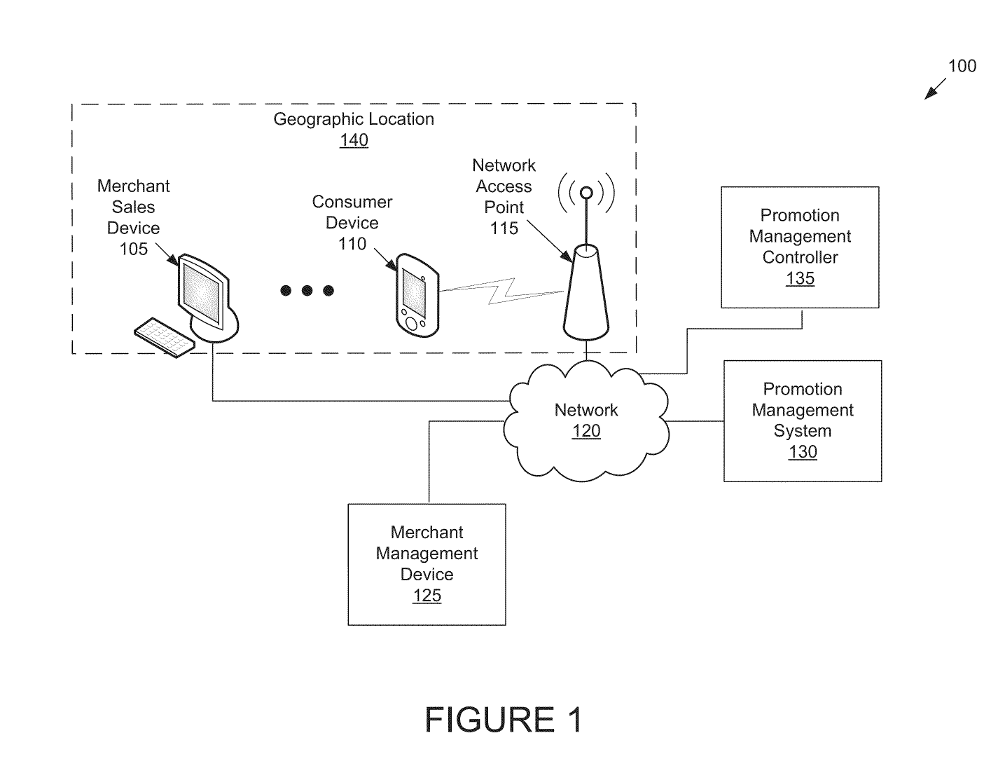

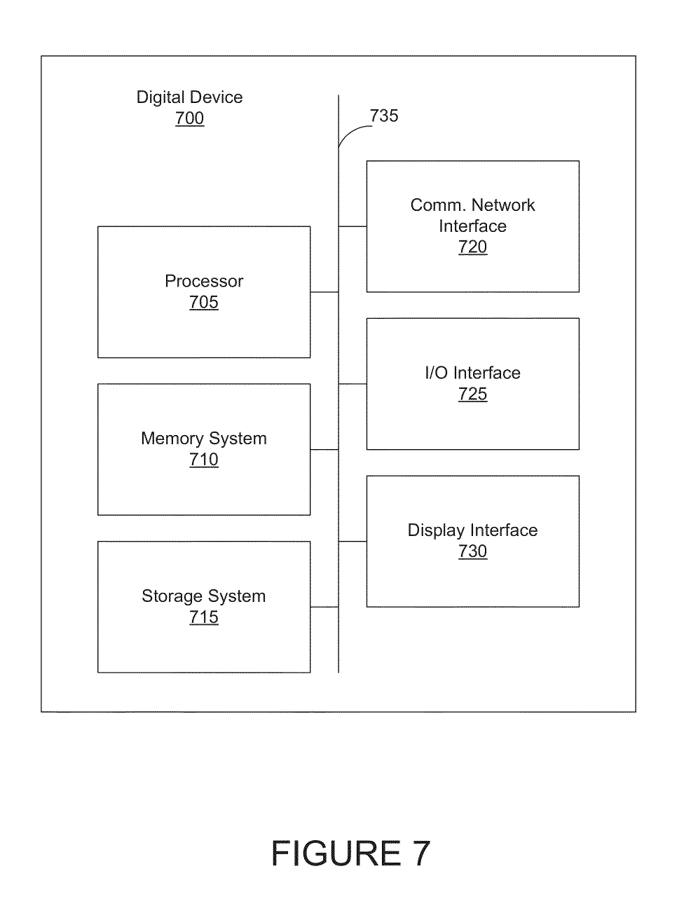

FIG. 1 depicts an exemplary promotion distribution environment 100, according to some embodiments. The promotion distribution environment 100 may include a merchant sales device 105, a customer device 110, a network access point 115, a network 120, a merchant management device 125, a promotion management system 130, and a promotion management controller 135. The merchant sales device 105, the customer device 110, the network access point 115, and the promotion management controller 135 may reside with a geographic location 140. One or more of the merchant sales device 105, the customer device 110, the network access point 115, the network 120, the merchant management device 125, the promotion management system 130, and the promotion management controller 135 may include elements of a computer system, an example of which is shown in FIG. 7. One or more of the merchant sales device 105, the customer device 110, the network access point 115, the network 120, the merchant management device 125, the promotion management system 130, and the promotion management controller 135, may comprise a laptop computer, a computing tablet, a mobile phone, or a desktop computer.

The merchant sales device 105 may manage payments related to a point of sale transaction. To this end, the merchant sales device 105 may receive payments, may update inventories, and may correlate payments with inventories. The merchant sales device 105 may be affiliated with a merchant. A “merchant,” as used herein, may refer to an entity that sells goods or services. A merchant may comprise a single store, a plurality of stores, or an entity that has an interest in many stores. A merchant may operate on various geographical levels. For example, a merchant may operate a single store with one geographic location. A merchant may also have multiple stores across a variety of geographical zones, including across a city, a county, a state, a region of a country, or a country. Each of these geographical zones may have offices affiliated with them. For instance, a merchant may have a central office to centrally manage all stores. The merchant may also have regional offices that manage stores on a regional level. Local offices of the merchant may manage stores on local level.

The merchant sales device 105 may be administered by a salesperson. The salesperson may be managed by the merchant. The salesperson may supervise the point of sale transaction at the merchant sales device 105. It is noted that the merchant sales device 105 may also be automated. That is, the merchant sales device 105 may perform point of sale transactions without human intervention by a salesperson.

The merchant sales device 105 may accept promotions. A “promotion,” as used herein, is an offer to redeem a discount for a product or service being sold at the merchant sales device 105. Promotions may take a variety of formats. For instance, promotions may include “flash promotions” and “regular promotions.” “Flash promotions,” as used herein may refer to promotions that are time-limited in a very narrow sense. An example of a flash promotion is a promotion that lasts only an hour after it has been deployed to the customer device 110. A “regular promotion,” in contrast may refer to a promotion that is time-limited to a lesser extent than a flash promotion or is not time-limited at all. A promotion may include a timer that counts down the time that remains before the promotion expires.

A promotion may have a target. A “target,” as used herein, may refer to a set of locations to which the promotion may be provided. A target may include some or all of the stores of a merchant. A target may include some or all of the stores in a facility. A target may further include some or all of the departments of a store, areas of a city, and other sets of locations to which a promotion may be provided.

Promotions may have promotion codes. A “promotion code,” as used herein, may refer to a code used to redeem a promotion. The promotion code may also take a variety of formats. The promotion code may comprise an alphanumeric string. The promotion code may also comprise an image, such as a barcode or a Quick Response (QR) Code. The promotion code may be entered into the merchant sales device 105 to redeem a discount. The entry of the promotion code may include human input by the salesperson. For instance, the salesperson may use a keyboard to enter an alphanumeric promotion code. However, it is noted that the entry of the promotion code need not require the salesperson. That is, a customer may scan a bar- or QR promotion code, or otherwise machine read the promotion code, to automatically redeem a discount on an item. The promotion code may be provided to the merchant sales device 105 through the display of the customer device 110.

The merchant sales device 105 may report redemption of promotions to the other modules of the promotion distribution environment 100. When a promotion code is redeemed at the merchant sales device 105, the merchant sales device 105 may send, through the network 120, information about the redemption to the promotion management system 130 and/or the promotion management controller 135. It is noted that other modules of FIG. 1 may send information about redemption. For instance, one or more of the customer device 110, the network access point 115, the merchant management device 125, and the promotion management controller 135 may send information about redemption. Moreover, although the merchant sales device 105 is shown coupled to the network 120, it is noted that the merchant sales device 105 need not be coupled to the network 120. More specifically, in various embodiments, the merchant sales device 105 may simply facilitate point-of-sale transactions without incorporating any network connection whatsoever. Further, the merchant sales device 105 may also be proximate to another device that is coupled to the network 105. For example, in some embodiments, the merchant sales device 105 may facilitate point-of-sale transactions without incorporating any network connection, but may be located near another device (not shown in FIG. 1) that is coupled to the network 120. Accordingly, the merchant sales device 105 may cooperate with the other device to provide transaction reporting calls.

The merchant sales device 105 may include: a cash register with a network connection, a laptop computer, a computing tablet, a mobile phone, or a desktop computer. It is noted, however, that the merchant sales device 105 need not comprise a digital device, and that promotions may be redeemed manually by a salesperson.

The customer device 110 may allow a customer to view and redeem promotions. A “customer” as used herein, may refer to an entity that buys goods or services from the merchant. A customer may comprise a single person, a group of people, or a business seeking to purchase items. The customer may include, a focused customer seeking to purchase a specific set of items in the geographic location 140, a casual customer who wishes to browse items for sale in the geographic location 140, or a customer who is not interested in buying anything at all but desires to use the geographic location 140 for noncommercial reasons.

The customer device 110 may support multiple network modes. For instance, the customer device 110 may support a first mobile data mode that is linked to a wireless data carrier. The customer device 110 may also include a second data mode that need not be linked to the wireless data carrier. Examples of the first data mode include Third Generation (3G) or Fourth Generation (4G) networks, while example of the second data mode may include an 802.11 or Wi-Fi data mode.

The second data mode may be associated with data from the network access point 115. It is noted that the customer device 110 may seek to enter the second data mode manually or without human intervention. For instance, the customer device 110 may present a customer with a graphical user interface (GUI) that allows the customer to manually change from the first data mode to the second data mode. As another example, applications on the customer device 110 or the operating system of the customer device 110 may automatically seek to enter the second data mode when an access point affiliated with the second data mode has been detected.

The customer device 110 may execute a customer application. A “customer application,” as used herein, may refer to an application used to view, manage, and redeem promotions. In some embodiments, the customer application may monitor when the customer device 110 seeks to access the network access point 115. When the customer device 110 seeks to access the network access point 115, the promotion management controller 135 may present the customer device 110 with a network entry page. The network entry page may provide terms and conditions of network access and may also ask the customer if she wants to opt in to promotions. The network entry page may also provide a portal to promotions by a set of merchants in the geographic location 140. The customer device 110 may also receive promotion screens, which display particular promotions that are relevant to the customer device 110 and/or the geographic location 140.

If the customer opts into promotions, the customer application may pull relevant promotions from the promotion management controller 135 to the customer device 110. Promotions may be grouped in various ways, including, without limitation: by item category, by store department, by merchant, by geographically targeted factors, or in other ways. The customer application may give the customer the option of selecting promotions that the customer finds to be of interest. The customer application may further provide the customer with promotion codes associated with selected promotions. The customer application may provide the customer with a way to redeem the promotion code. For example, the customer application may display the promotion code on the screen of the customer device 110 for later redemption at the merchant sales device 105. The customer application may monitor a device identifier, such as a Media Access Controller (MAC) address, associated with the customer device 110. The customer application may also provide information about the customer's browsing behavior and purchasing behavior to the promotion management controller 135.

The customer application on the customer device 110 may be embodied in a web browser or a mobile application. For instance, the customer application may be presented as a series of web pages. The customer application may also be presented as a standalone mobile application that is managed by the geographic location 140 or a third party.

The network access point 115 may mange access to the network 120. To this end, the network access point 115 may support connections of the devices, e.g., the customer device 110, to the network 120. In various embodiments, the network access point 115 may administer a wireless network for the geographic location 140. The network administered by the network access point 115 may include a localized wireless network, such as an 802.11 network. It is noted that the network access point 115 may implement networks other than localized wireless networks without departing from the scope and substance of the inventive concepts discussed herein. The network access point 115 may cooperate with the customer device 110 and the promotion management controller 135 to pull promotions from the promotion management controller 135 to the customer device 110. The network access point 115 may also cooperate with the promotion management controller 135 to provide analytics related to the customer device 110. It is noted that, element 115 shows a single network access point in FIG. 1, the element 115 may refer to multiple network access points that cooperate to provide network services for the geographic location 140.

The network 120 may include a computer network. The network 120 may include technologies such as Ethernet, 802.11, worldwide interoperability for microwave access (WiMAX), 3G, 4G, CDMA, GSM, LTE, digital subscriber line (DSL), etc. The network 120 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 120 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

The merchant management device 125 may allow a merchant to manage promotions. The merchant management device 125 may execute a promotion management application. A “promotion management application,” as used herein, may refer to an application used to create new promotions or manage existing promotions. The promotion management application may present a merchant with a set of GUIs to develop and deploy promotions to the promotion management controller 135. Resources for the promotion management application may be provided by the promotion management system 130. In various embodiments, the promotion management application may be presented in a web browser of the merchant management device 125. For instance, the promotion management application may be presented in a web portal accessible by the merchant management device 125. The promotion management application may also be presented in a standalone application on the merchant management device 125.

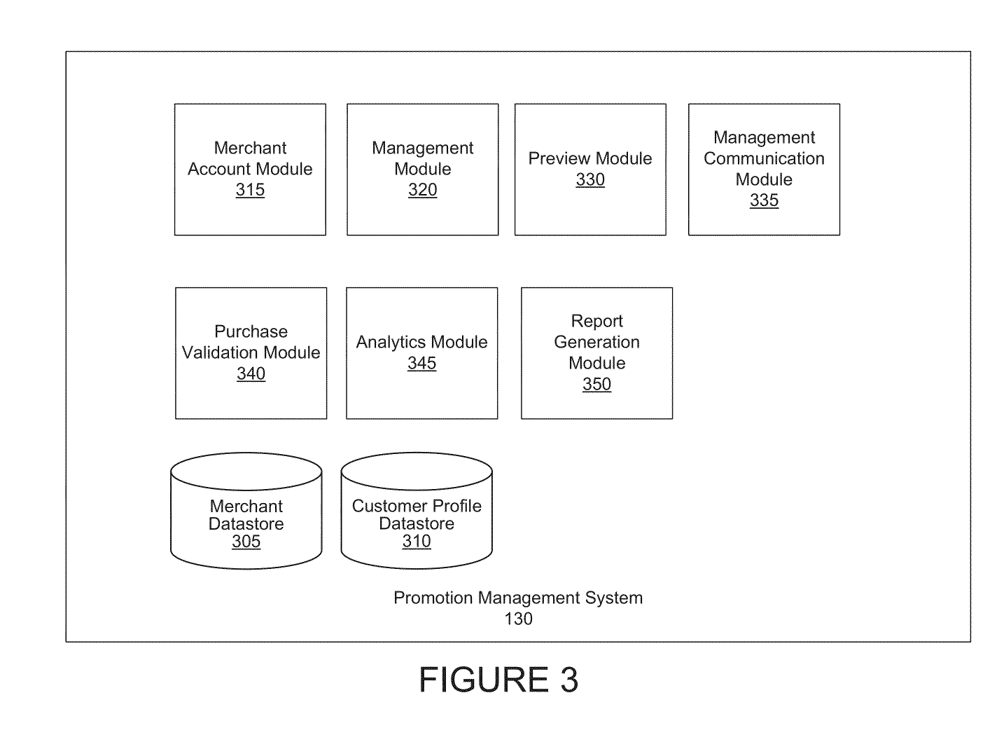

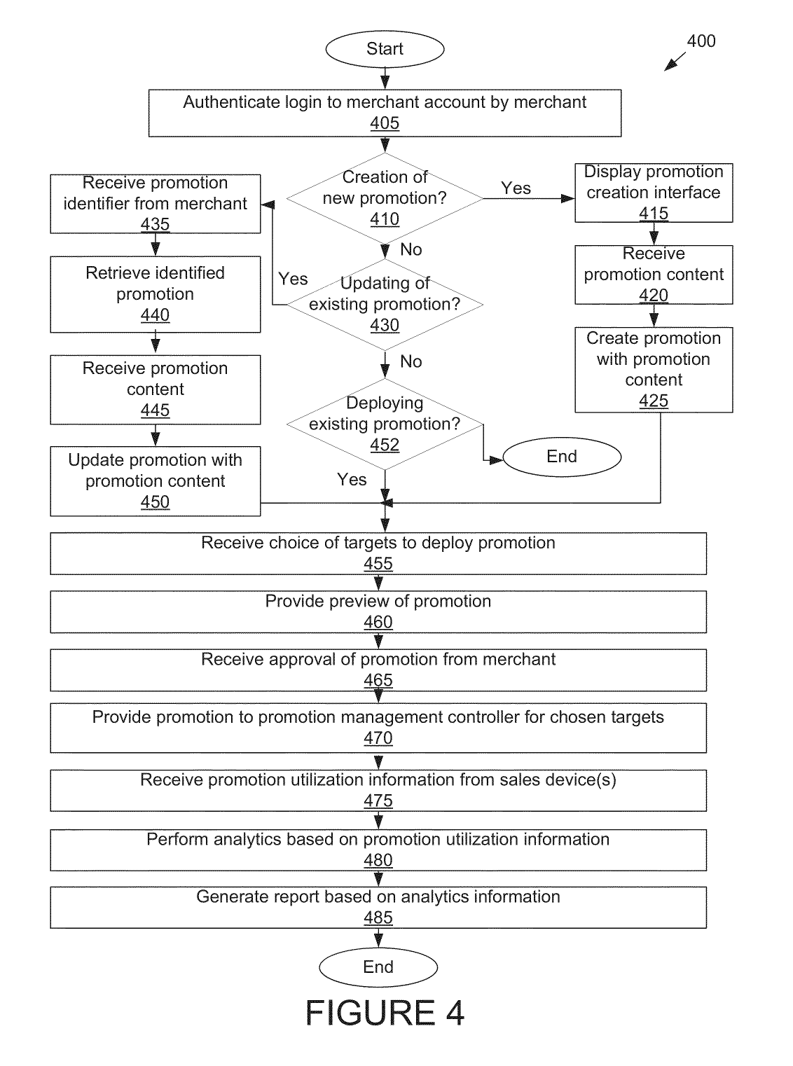

The promotion management system 130 may support the promotion management application on the merchant management device 125. The promotion management system 130 may support creating, managing, and deploying promotions to targets. In some embodiments, the promotion management system 130 may be hosted on cloud services and may expose interfaces to one or more databases. A merchant may access the promotion management system 130 through the interfaces via the promotion management application on the merchant management device 125. The promotion management system 130 is further discussed in the context of FIG. 3 and FIG. 4.

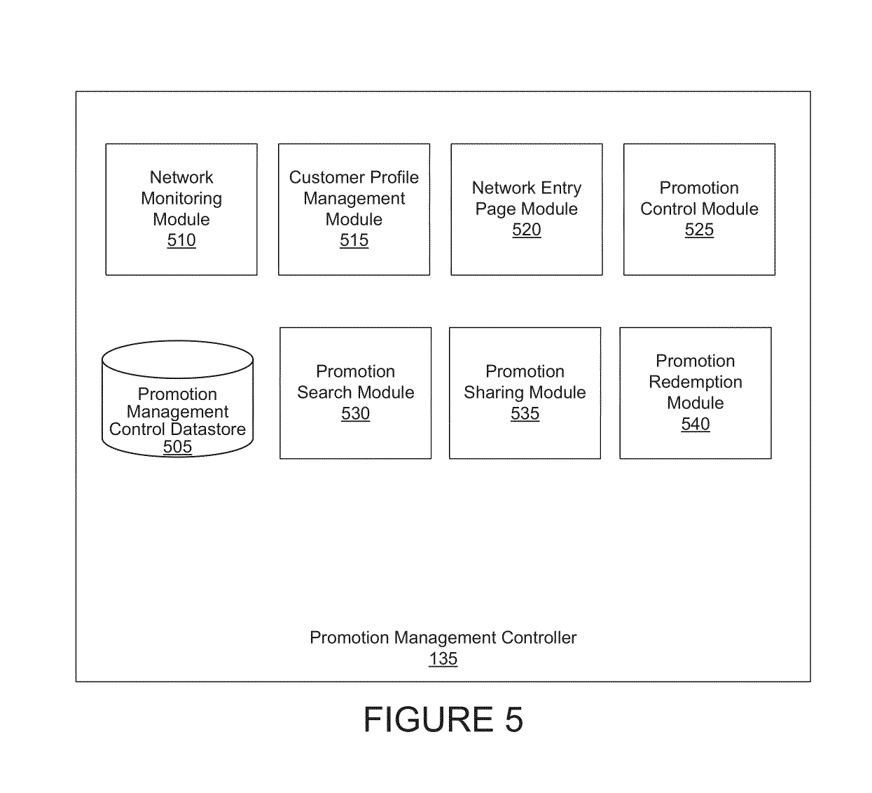

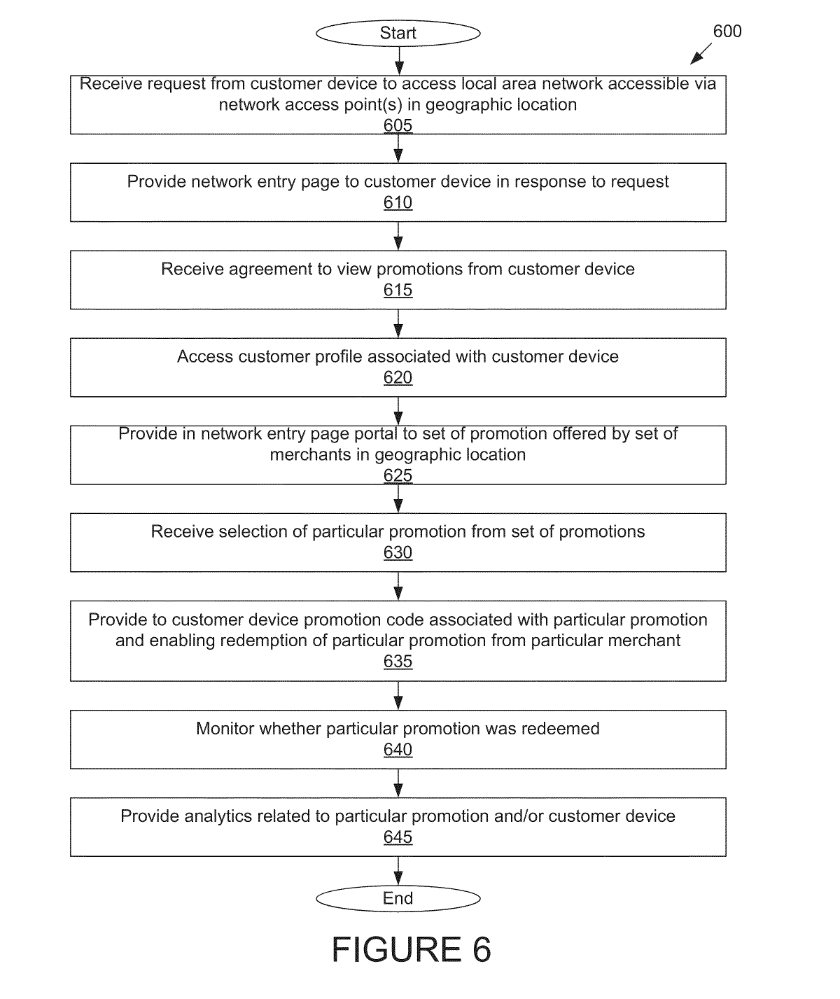

The promotion management controller 135 may control access to the network access point 115. To this end, the promotion management controller 135 may incorporate a cloud-based controller that manages connections between the customer device 110 and the network access point 115. The promotion management controller 135 may also manage network access screens, promotion screens, and other content on the customer device 110. The promotion management controller 135 may also manage the flow of promotions to the customer device 110. More specifically, the promotion management controller 135 may receive promotions from the promotion management system 130 and may provide relevant promotions to the customer device 110. In various embodiments, the promotion management controller 135 may monitor the customer device 110 and/or the merchant sales device 105 for analytics about the redemption of specific promotions and customer behavior. For instance, the promotion management controller 135 may include transaction reporting calls that present to the promotion management system 130 whether a promotion has been redeemed. The promotion management controller 135 may further provide information that a customer has willingly shared (e.g., demographic information) to the promotion management system 130. The discussion accompanying FIG. 5 and FIG. 6 further discuss the promotion management controller 135.

The geographic location 140 may comprise any geographic locale where it is possible to have a shared network. The geographic location 140 may include one or more merchants and may facilitate commercial activity. In some embodiments, the geographic location 140 may comprise a mall, such as a shopping mall. The shopping mall may be an indoor mall or an outdoor mall. It is noted that the geographic location 140 may also comprise an airport, concourse, train station, bus station, shopping plaza, restaurant, downtown area, library, cruise ship, park, office building, school, or other area. The geographic location 140 may cover the customer device 110 and/or the network access point 115. The geographic location 140 may also cover the merchant sales device 105.

In various embodiments, the geographic location 140 may include at least a portion of the merchant management device 125. For example, a merchant operating the merchant management device 125 may be using a computer located within the geographic region 140. The geographic location 140 may also include at least a portion of the promotion management controller 135. More specifically, the promotion management controller 135 may include an architecture that is distributed between the geographic location 140 and other locations. For instance, the promotion management controller 135 may include some portions that reside on cloud-based servers, and other portions that reside within the geographic location 140. The promotion management controller could include portions that reside locally to the network access point 115. Similarly, the geographic location 140 may or may not include at least a portion of the promotion management system 130.

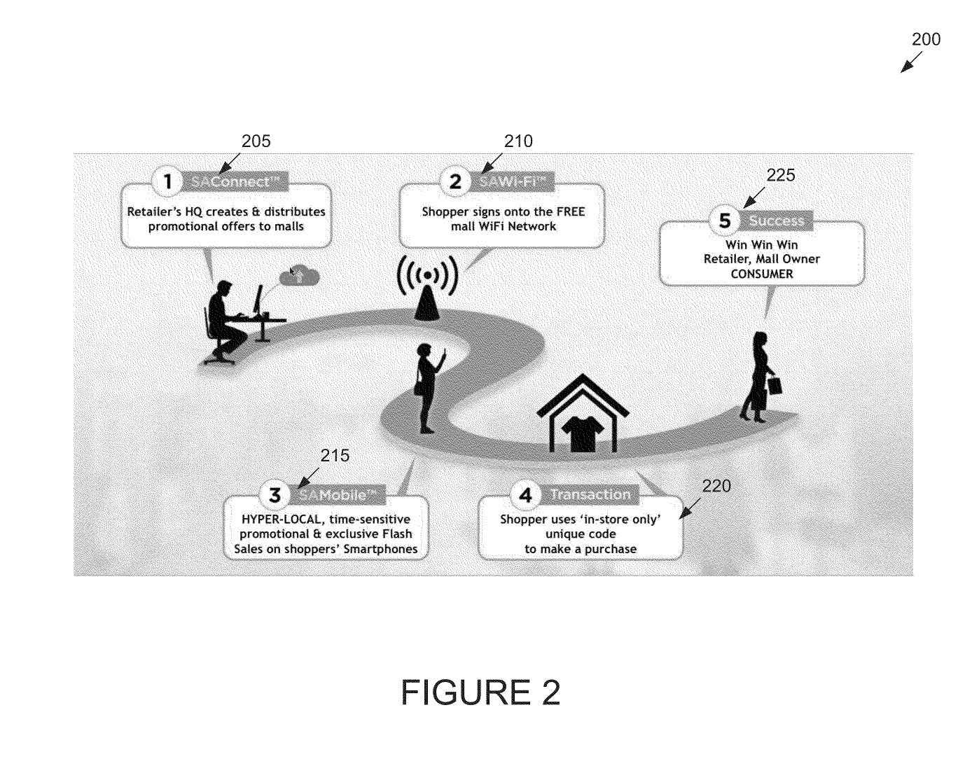

FIG. 2 depicts a flowchart 200 of an exemplary method for distributing promotions, according to some embodiments. The flowchart 200 is discussed in conjunction with the promotion distribution environment 100, shown in FIG. 1.

At block 205, the merchant management device 125 may create and distribute promotions to targets, including facilities such as malls. The merchant management device 125 may use the promotion management application to create these promotions. As the promotion management application may execute on a web browser of the merchant, the merchant need only have access to a computer with a web browser and need not have any specialized software to create the promotions. Moreover, the promotions may vary in scope, which may depend on the organizational role of the user of the merchant management device 125. For instance, a user affiliated with a local store may create a local promotion, a user affiliated with a merchant on a regional level may create a regional promotion, while a user affiliated with a merchant's central offices may create a promotion that applies to all stores. The promotions created by the merchant management device 125 may include flash promotions or regular promotions. The type of promotion may depend on the needs of the merchant, and may vary on factors such as the time of year or the inventory the merchant has at specific locations. The promotions from the merchant management device 125 may be pushed to the promotion management controller 135.

At block 210, the customer device 110 may login the network 120 through the network access point 115. The customer device 110 may be seeking access to the network 120 for a variety of reasons. One reason may be that the network 120 may include an 802.11 network, and that the customer device 110 may seek to transition from a paid data plan to a free network or a network without limited access. The customer device 110 may initiate access to the network 120 through its operating system, through an application on the customer device 110, or through human intervention. As part of signing onto the network 120, the customer device 110 may agree to receive promotions.

At block 215, the promotion management controller 135 may provide the customer device 110 with the promotions created and distributed by the merchant management device 125. The promotion management controller 135 may provide the customer device 110 with promotions that are occurring in the vicinity of the customer device 110. The resulting promotions may draw the interest of the customer and incentivize purchases that the customer may not otherwise make or be aware of. The promotions may include a promotion code.

At block 220, the customer affiliated with the customer device 110 may use the promotion code to make a purchase at the merchant sales device 105. In some embodiments, the customer may manually present the promotion code to a sales clerk administering the merchant sales device 105. The customer may also use the promotion code as part of an automated checkout process.

At block 225, the promotion management controller 135 may monitor whether the promotion was redeemed. The promotion management controller 135 may provide the customer's device information, redemption information, and other information to the promotion management system 130, which in turn, may perform analytics relating to the customer device 110.

FIG. 3 depicts an exemplary promotion management system 130, according to some embodiments. The promotion management system 130 may include a merchant datastore 305, a customer profile datastore 310, a merchant account module 315, a management module 320, a preview module 330, a management interface 335, a purchase validation module 340, an analytics module 345, and a report generation module 350.

The merchant datastore 305 may include a database embodied on a non-transitory computer-readable medium. The merchant datastore 305 may store merchant profiles and promotion profiles. A merchant profile, as stored in the merchant datastore 305, may include merchant fields that identify a merchant. Merchant fields may include a merchant's name, locations, facilities with which the merchant is associated, departments which the merchant may incorporate, products the merchant stores, links to specific promotions the merchant may provide, and other information. The merchant profile may also include account names and passwords of users associated with the merchant. The merchant profile may also include the level of access a specific user is entitled to have with respect to the merchant profile.

A promotion profile, as stored in the merchant datastore 305, may include promotion fields to identify a promotion. Promotion fields may include: a promotion title, a promotion description, promotion details, and a promotion discount code. The promotion discount code may include an alphanumeric string, may comprise an image (e.g., a bar code or QR code), or may have another format to identify the discount. Promotion fields may also store a system and/or item number for a merchant to internally identify the promotion. The promotion fields may further store pricing information about a promotion. Examples of pricing information may include a promotion type, the selling price of an item being promoted, the highest or lowest regular price for the item, and other price-related information. The promotion fields may further store how the promotion will be classified with other promotions (e.g., storewide, by department, by item classification, or by item sub-classification). In various embodiments, the promotion fields may store a redemption window for a promotion, an image associated with the promotion, a file that stores how the promotion will be rendered on a mobile device, particular stores selected for the promotion, the maximum number of redemptions permitted for the promotion, the promotion deployment range, and other information about the promotion.

The customer profile datastore 310 may also include a database embodied in a non-transitory computer-readable medium. The customer profile datastore 310 may store customer information. Stored customer information may include devices associated with a customer, a customer's past redemptions of promotions, and facilities/stores/departments a customer has been associated with. Stored customer information may further include a customer's browsing behavior and data that the customer has agreed to share with the promotion management system 130.

The merchant account module 315 may manage a merchant's accounts. The merchant account module 315 may include interfaces that authenticate access to a merchant profile stored on the merchant datastore 305. For instance, the merchant account module 315 may manage usernames and passwords, may maintain the security of connections to the merchant datastore 305 and/or the merchant management device 125. The merchant account module 315 may also manage the promotion management application.

The merchant account module 315 may manage role-based access to the merchant datastore 305. Role-based access may include varying degrees of access to different users based on the role the users play with respect to the merchant. For instance, the merchant account module 315 may manage one level of access to an employee who works for with the central office of a merchant, another level of access to an employee who works for with a regional office of the merchant, and yet another level of access to an employee who works for a physical store of the merchant.

The management module 320 may create new promotions and access existing promotions in the merchant datastore 305. The management module 320 may support interfaces with the merchant management device 125 that allow for the creation of new promotions. The management module 320 may also update or modify existing promotion profiles in the merchant datastore 305. The management module 320 may further add content to promotions. More specifically, the management module 320 may be configured to update the fields of promotion profiles. The input used to update a promotion profile may be obtained through the promotion management application.

The preview module 330 may allow a merchant to preview how the customer device 110 would view the promotion. The preview module 330 may provide an emulator to the promotion management application. The emulator may render a selected promotion in a format similar to the format used by an application (e.g., a web browser or a mobile application) on the customer device 110.

The management interface 335 may provide a promotion to the promotion management controller 135. The management interface 335 may provide the promotion as a web page or as a portion of a mobile application over the network 120. The management interface 335 may select a set of facilities, stores, or departments to deploy the promotion.

The purchase validation module 340 may validate whether specific promotions have been validated. More specifically, the purchase validation module 340 may track, based on information, from the promotion management controller 135, whether customers have redeemed specific purchases. As discussed, purchase validation information may come from the promotion management controller 135 and/or the merchant sales device 105. The purchase validation module 340 may provide purchase validation information to the analytics module 345.

The analytics module 345 may determine analytics related to promotions. As discussed, analytics may be related to knowledge of customer behaviors, purchase validations, and other information. The analytics module 345 may receive purchase validation information from the purchase validation module 340. The analytics module 345 may also monitor all actions (e.g., all clicks or application events) of a customer in the customer application. Based on the monitored actions, the analytics module may provide customer information to update promotion profiles in the merchant datastore 305, customer profiles in the customer profile datastore 310, and other data. The analytics module 345 further provide trends, and graphical displays of analytics information in the promotion management application.

The report generation module 350 may present the state of a set of promotions. In various embodiments, the reports may be based on analytics information from the analytics module 345. The reports may include real-time or near-real-time reports of the state of the set of promotions.

FIG. 4 depicts a flowchart 400 of an exemplary method for managing promotions, according to some embodiments. The flowchart 400 is discussed in conjunction with the promotion distribution environment 100, shown in FIG. 1 and the promotion management system 130, shown in FIG. 3.

At block 405, the merchant account module 315 may authenticate a login to a merchant account by a merchant. The login may include role-based access to the merchant account. The merchant account module 315 may allow a user associated with a merchant to log into the merchant account at an appropriate level of access for the user.

At decision point 410, the management module 320 may determine whether to create a new promotion. If it is determined that a new promotion is to be created, the flowchart 400 may proceed to block 415. If it is not determined that a new promotion is to be created, the flowchart 400 may proceed to decision point 430.

At block 415, the management module 320 may display a promotion creation interface. The promotion creation interface may be displayed in a promotion management application. At block 420, the management module 320 may receive promotion content. The promotion content may include data used to populate the fields of the new promotion. At block 425, the management module 320 may create a promotion with promotion content. Creating the promotion with the promotion content may include populating the fields of the promotion with the promotion content provided by the merchant.

At decision point 430, the management module 320 may determine whether to update an existing promotion. If it is determined that an existing promotion is to be updated, the flowchart 400 may proceed to block 435. If it is not determined that an existing promotion is to be updated, the flowchart 400 may proceed to decision point 452.

At block 435, the management module 320 may receive a promotion identifier from a merchant. The management module 320 may receive a promotion name or other promotion identifier from the merchant management device 125. At block 440, the management module 320 may retrieve the identified promotion from the merchant datastore 305. At block 445, the management module 320 may receive promotion content. The promotion content may be provided by the merchant management device 125. At block 450, the management module 320 may update the promotion with the promotion content. The management module 320 may populate the fields of the promotion with the provided promotion content.

At decision point 452, the management module 320 may determine whether to deploy an existing promotion. If it is determined that an existing promotion is to be deployed, the flowchart 400 may continue to block 455. If it is not determined that an existing promotion is to be deployed, the flowchart 400 may end.

At block 455, the management module 320 may receive a choice of targets to deploy the promotion. The merchant management device 125 may provide targets to deploy the promotion. Examples of targets include facilities, merchants, item categories, item classifications, and item sub-classifications.

At block 460, the preview module 330 may provide a preview of the promotion. The preview module 330 may render the promotion so that the promotion appears as it would in the customer device 110. At block 465, the management module 320 may receive an approval of the promotion from the merchant. The approval may come from the merchant management device 125. At block 470, the management interface 335 may provide the promotion to the promotion management controller 135 for a the chosen targets. At block 475, the purchase validation module 340 may receive promotion utilization information from the merchant sales device 105. At block 480, the analytics module 345 may perform analytics based on the promotion utilization information. At block 485, the report generation module 350 may generate a report based on the analytics information.

FIG. 5 depicts an exemplary promotion management controller 135, according to some embodiments. The promotion management controller 135 may include a promotion management control datastore 505, a network monitoring module 510, a customer profile management module 515, a network entry page module 520, a promotion control module 525, a promotion search module 530, a promotion sharing module 535, and a promotion redemption module 540.

The promotion management control datastore 505 may include a database embodied on a non-transitory computer-readable medium. The promotion management control datastore 505 may store network access information and customer profiles. Network access information, as stored in the promotion management control datastore 505, may include configuration parameters of the network 120, devices that have previously been authenticated to access the network 120, and other information. Customer profiles, as stored in the promotion management control datastore 505, may include customer names, devices associated with customers, customers' past purchases, analytics gathered about customers, and other information.

The network monitoring module 510 may determine whether a device is attempting to access the network 120. To this end, the network monitoring module 510 may monitor network access requests made to the network 120. The network monitoring module 510 may also capture device identifiers of devices attempting to access the network 120. In various embodiments, the network monitoring module 510 may store device identifiers of devices seeking access in the promotion management control datastore 505. The network monitoring module 510 may provide the device identifiers to the customer profile management module 515.

The customer profile management module 515 may manage customer profiles in the promotion management control datastore 505. The customer profile management module 515 may create new customer profiles for devices that seek to access the network 120 for the first time. The customer profile management module may also modify existing customer profiles for devices that have previously accessed the network 120.

The network entry page module 520 may provide a network entry page to the customer application. The network entry page may provide content that the customer device 110 first sees when the customer device 110 attempts to access the network 120.

The promotion control module 525 may provide promotion pages to the customer application. Promotion pages may provide categories of items being promoted to the customer device 110. The categories may be limited to the facility that the customer is in. The terms and conditions button on the network entry page may link the customer to the promotion pages. The promotion pages may also include promotion codes for promotions. Promotion pages may group promotions in various ways, including: by item category, by store department, by merchant, etc. Promotion pages may further group promotions based on geographically targeted factors, such as the device identifier of the customer device 110, the facility in which the network access point 115 is present, and customer profile information related to the customer device 110.

The promotion control module 525 may receive customer input with respect to the promotion pages. As a result, the promotion control module 525 may determine specific promotions that a customer has selected or has redeemed. Based on customer input, the promotion control module 525 may update customer profiles in the promotion management control datastore 505. The promotion control module 525 may also provide the customer input to the promotion redemption module 540.

The promotion search module 530 may allow customers to search promotions. The promotion sharing module 535 may allow customers to share promotions. Examples of sharing include email, text messaging, and social networking.

The promotion redemption module 540 may track whether a customer redeemed specific promotions. The promotion redemption module 540 may receive customer input regarding specific promotions from the promotion control module 525. In some embodiments, the promotion redemption module 540 may track other customer behavior, including how the customer interacted with the customer application. The promotion redemption module 540 may report customer behavior to analytics modules of the promotion management system 130.

FIG. 6 depicts a flowchart 600 of an exemplary method for providing promotions, according to some embodiments. The flowchart 600 is discussed in conjunction with the promotion distribution environment 100, shown in FIG. 1 and the promotion management controller 135, shown in FIG. 5.

At block 605, the network monitoring module 510 may receive a request from the customer device 110 to access the network 120 via the network access point 115 in the geographic location 140. The request to access the network 120 may occur when an application on the customer device 110 seeks to transition to the network 120. For instance, a web browser application or a social networking application on the customer device 110 may seek to transition from a 4G network to a 802.11 network. The request to access the network 120 may also be initiated by the operating system of the customer device 110. In various embodiments, the network monitoring module 510 may then record the device identifier of the customer device 110. For example, the network monitoring module 510 may record the MAC address of the customer device 110. The network monitoring module 510 may forward the device identifier to other modules, such as the promotion management control datastore 505, in the promotion management controller 135.

At block 610, the network entry page module 520 may provide a network entry page to the customer device 110 in response to the request. The network entry page may be incorporated into an application, such as a web browser or a mobile application on the customer device 110. The network entry page may include a terms and conditions link, and a terms and conditions button. The terms and conditions link may display terms and conditions of network access. The terms and conditions button may indicate that the customer agrees to the terms and conditions of network access.

At block 615, the network entry page module 520 may receive an agreement to view promotions from the customer device 110. In various embodiments, the terms and conditions of network entry may include an agreement to view promotions. As a result, a customer's selection of the terms and conditions button may indicate that the customer agrees to view promotions. In some embodiments, the network entry page module 520 may provide a separate button that asks whether a customer agrees to view promotions. The customer's selection of that button may indicate that the customer agrees to view promotions. In specific embodiments, the network entry page module 520 may provide a searchable list of current promotions.

At block 620, the customer profile management module 515 may access a customer profile associated with the customer device 110. If the customer profile management module 515 determines that it was the first time the customer device 110 attempted to enter the network 120, the customer profile management module 515 may create a new customer profile in the promotion management control datastore 505. If the customer profile management module 515 determines that the customer device 110 previously attempted to enter the network 120, the customer profile management module 515 may modify an existing customer profile in the promotion management control datastore 505.

At block 625, the promotion control module 525 may provide, in the network entry page, a portal to a set of promotions offered by a set of merchants in the geographic location 140. The portal may list promotion categories such as a list of promotions by item category, by store department, by merchant, by geographically targeted factors, or in other ways. The promotion categories may be selectable by the customer within the customer application.

At block 630, the promotion control module 525 may receive a selection of a particular promotion from the set of promotions. In various embodiments, the customer may choose a particular promotion category from the list that was provided in the customer application. The promotion control module 525 may further, based on the particular promotion categories, the facility containing the customer device 110, and the customer profile associated with the customer device 110, provide a set of promotions. The set of promotions may include information such as: promotion titles, promotion descriptions, and promotion details. The customer may choose a particular promotion from the set of promotions displayed in the customer application.

At block 635, the promotion control module 525 may provide to the customer device 110 a promotion code associated with the particular promotion. The promotion code may enable redemption of the particular promotion from a particular merchant from the set of merchants. The promotion code may include an alphanumeric character string or may include an image such as a barcode or a QR code. The customer application may display the promotion code in a format that is convenient for the customer to use at the merchant sales device 105. For instance, an alphanumeric code may be presented to the customer to manually show a sales clerk operating the merchant sales device 105. Moreover, a barcode or a QR code may be displayed in the customer application so that the customer can use automated checkout procedures at the merchant sales device 105.

At block 640, the promotion redemption module 540 may monitor whether the particular promotion was redeemed. The promotion redemption module 540 may receive notifications from the merchant sales device 105 as to whether the particular promotion was redeemed. The promotion redemption module 540 may provide whether the promotion was redeemed to the promotion control module 525.

At block 645, the promotion control module 525 may provide analytics related to the particular promotion and/or the customer device 110. For instance, the promotion control module 525 may provide information related to the browsing behavior of the customer, whether a specific customer redeemed a specific promotion, and how the customer interacted with specific promotions by specific merchants.

FIG. 7 depicts a digital device 700, according to some embodiments. The digital device 700 comprises a processor 705, a memory system 710, a storage system 715, a communication network interface 720, an I/O interface 725, and a display interface 730 communicatively coupled to a bus 735. The processor 705 may be configured to execute executable instructions (e.g., programs). In some embodiments, the processor 705 comprises circuitry or any processor capable of processing the executable instructions.

The memory system 710 is any memory configured to store data. Some examples of the memory system 710 are storage devices, such as RAM or ROM. The memory system 710 may comprise the RAM cache. In various embodiments, data is stored within the memory system 710. The data within the memory system 710 may be cleared or ultimately transferred to the storage system 715.

The storage system 715 is any storage configured to retrieve and store data. Some examples of the storage system 715 are flash drives, hard drives, optical drives, and/or magnetic tape. In some embodiments, the digital device 700 includes a memory system 710 in the form of RAM and a storage system 715 in the form of flash data. Both the memory system 710 and the storage system 715 comprise computer readable media which may store instructions or programs that are executable by a computer processor including the processor 705.

The communication network interface (com. network interface) 720 may be coupled to a data network via the link 740. The communication network interface 720 may support communication over an Ethernet connection, a serial connection, a parallel connection, or an ATA connection, for example. The communication network interface 720 may also support wireless communication (e.g., 802.11a/b/g/n, WiMAX). It will be apparent to those skilled in the art that the communication network interface 720 may support many wired and wireless standards.

The optional input/output (I/O) interface 725 is any device that receives input from the user and output data. The display interface 730 is any device that may be configured to output graphics and data to a display. In one example, the display interface 730 is a graphics adapter.

It will be appreciated by those skilled in the art that the hardware elements of the digital device 700 are not limited to those depicted in FIG. 7. A digital device 700 may comprise more or less hardware elements than those depicted. Further, hardware elements may share functionality and still be within various embodiments described herein. In one example, encoding and/or decoding may be performed by the processor 705 and/or a co-processor located on a GPU.

The above-described functions and components may be comprised of instructions that are stored on a storage medium such as a computer readable medium. The instructions may be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

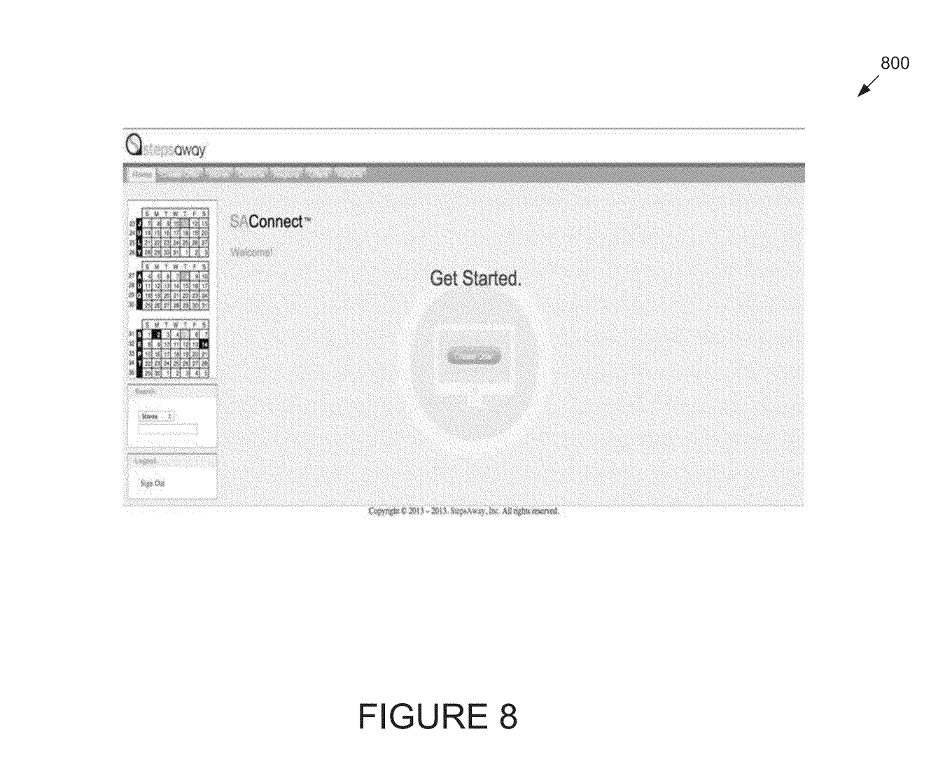

FIG. 8 depicts a welcome screen 800 of an exemplary promotion management application, according to some embodiments. The welcome screen 800 may have been captured from the merchant management device 125, shown in FIG. 1. The welcome screen 800 may include a set of tabs, such as the tabs labeled “Home,” “Create Offer,” Stores,” “Districts,” “Regions, “Offers,” and “Reports.” On the left hand side, the welcome screen 800 includes a calendar pane that shows promotions being managed in a calendar format. Below the calendar pane, the welcome screen 800 shows a search pane that allows a merchant to search promotions by various parameters, such as by store. Below the search pane, the welcome screen 800 includes a merchant account pane. The merchant account pane may include account management features such as the ability to login or logout of merchant account. In the middle of the welcome screen 800 resides the start pane. The start pane includes a welcome message “Welcome!” and a “Create Offer” button. In various embodiments, the “Create Offer” button may allow the merchant to begin the process of creating a promotion.

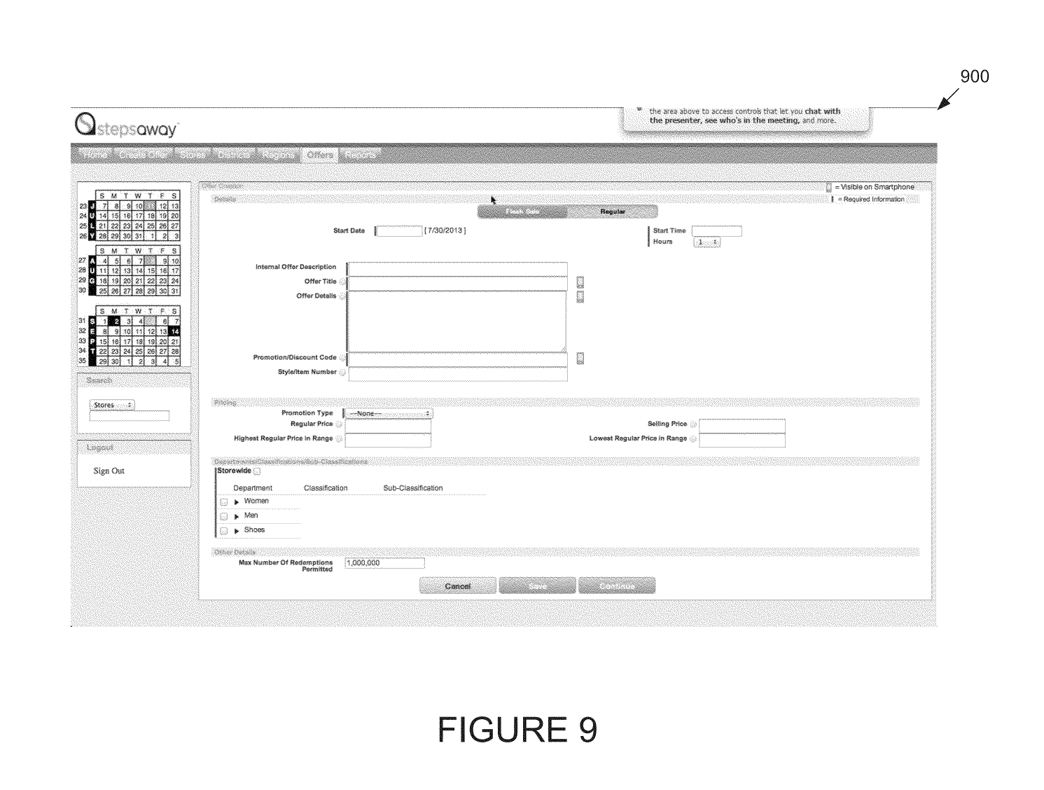

FIG. 9 depicts a pending promotions screen 900 of an exemplary promotion management application, according to some embodiments. The pending promotions screen 900 may appear on the merchant management device 125 after a merchant clicked the “Create Offer” button in the welcome screen 800, shown in FIG. 8.

The pending promotions screen 900 includes, in the middle, a promotion creation pane. The promotion creation pane may provide fields for a merchant to enter promotion content that corresponds to a promotion being created. A smartphone icon on the top right-hand side of the promotion creation pane may show which fields are to be visible on a smartphone. The promotions creation pane may include a flash promotion sub-pane and a regular promotion sub-pane. The flash promotion sub-pane may allow the merchant to create flash promotions, while the regular promotions sub-pane may allow the merchant to create regular promotions. In the example of FIG. 9, the flash promotions sub-pane is shown as selected.

The promotion creation pane of the pending promotions screen 900 may include start portions, such as a start date field, a start time field, and a duration marker. The duration marker has been set to create a default time of one hour for a flash promotion being created. It is noted that in various embodiments, the duration marker may be replaced by a duration field that allows a merchant to manually specify the amount of time a flash promotion will last.

The promotion creation pane of the pending promotions screen 900 may also include promotion information fields. The promotion information fields shown include an “Internal Offer Description” field, an “Offer Title” field, an “Offer Details” field, a “Promotion/Discount Code” field, and a “Style/Item Number” field. The “Internal Offer Description” field may allow a merchant to enter text for the promotion to be internally identified. The Offer Title” field, and the “Offer Details” field may allow the merchant to enter text for the promotion to be identified by customers. The “Promotion/Discount Code” field may allow the merchant to provide an alphanumeric promotion code. It is noted that, in some embodiments, the merchant may also upload an image (e.g., a barcode or a QR code) to the “Promotion/Discount Code” field.

The promotion creation pane of the pending promotions screen 900 may further include promotion pricing fields. The promotion pricing fields may include a promotion type marker, a “Regular Price” field, a “Selling Price” field, a “Highest Price in Range” field, and a “Lowest Price in Range” field. Each of the promotion pricing fields may allow a merchant to enter price details of the promotion being created.

The promotion creation pane of the pending promotions screen 900 may also include deployment fields to specify where the promotion being created should be deployed. Deployment fields shown in FIG. 9 include a “Storewide” deployment, deployment by “Department,” “Classification,” and “Sub-Classification.” In the pending promotions screen 900, a merchant may deploy the promotion being created storewide, or to the following departments: women, men, and shoes. The promotions creation pane also allows a merchant to specify the maximum number of redemptions possible. At the bottom of the pending promotions screen 900 are the options to cancel creating a promotion, to save a promotion being created, and to continue through the process of creating the promotion.

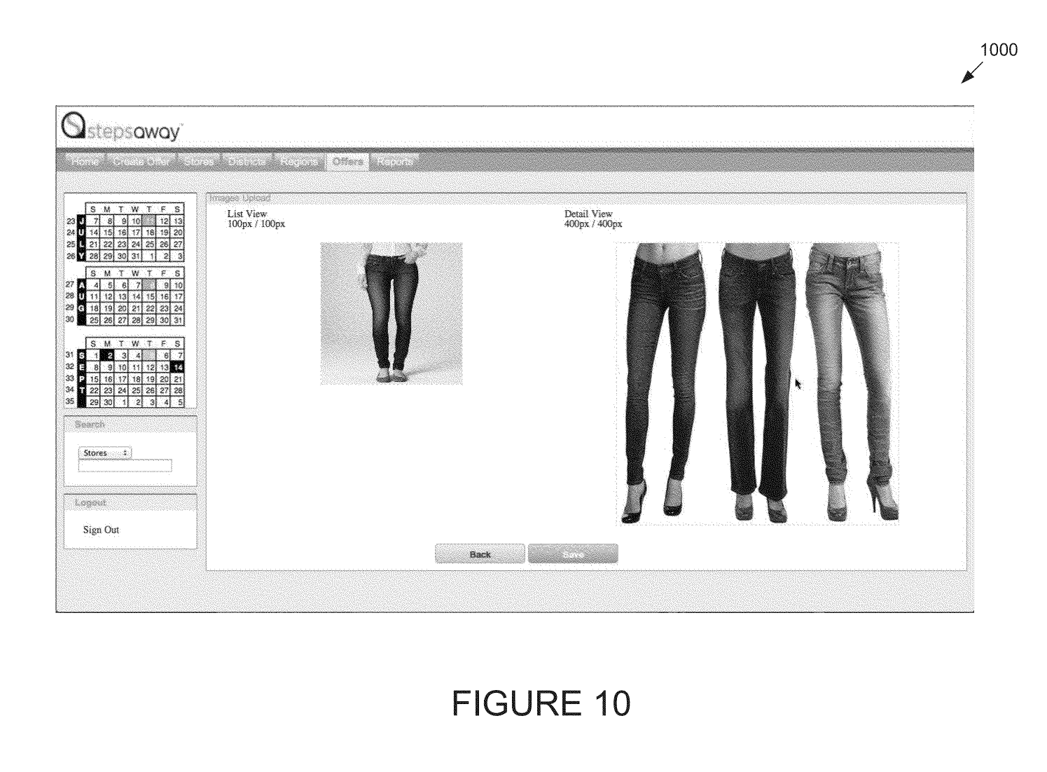

FIG. 10 depicts a promotion image upload screen 1000 of an exemplary promotion management application, according to some embodiments. A merchant may have been linked to the promotion image upload screen 1000 after the merchant clicked on the “Continue” button at the bottom of the pending promotions screen 900 shown in FIG. 9. The promotion image upload screen 1000 may allow a merchant to upload an image associated with the promotion being created. The promotion image upload screen 1000 may allow for multiple images of a promotion to be uploaded. For example, the promotion image upload screen 1000 may allow a merchant to upload a list view of a promotion having a first resolution of 100 pixels, and a detail view of the promotion having a second resolution of 400 pixels. The promotion image upload screen 1000 may allow the merchant to cancel the image upload or save the image to the promotion being created.

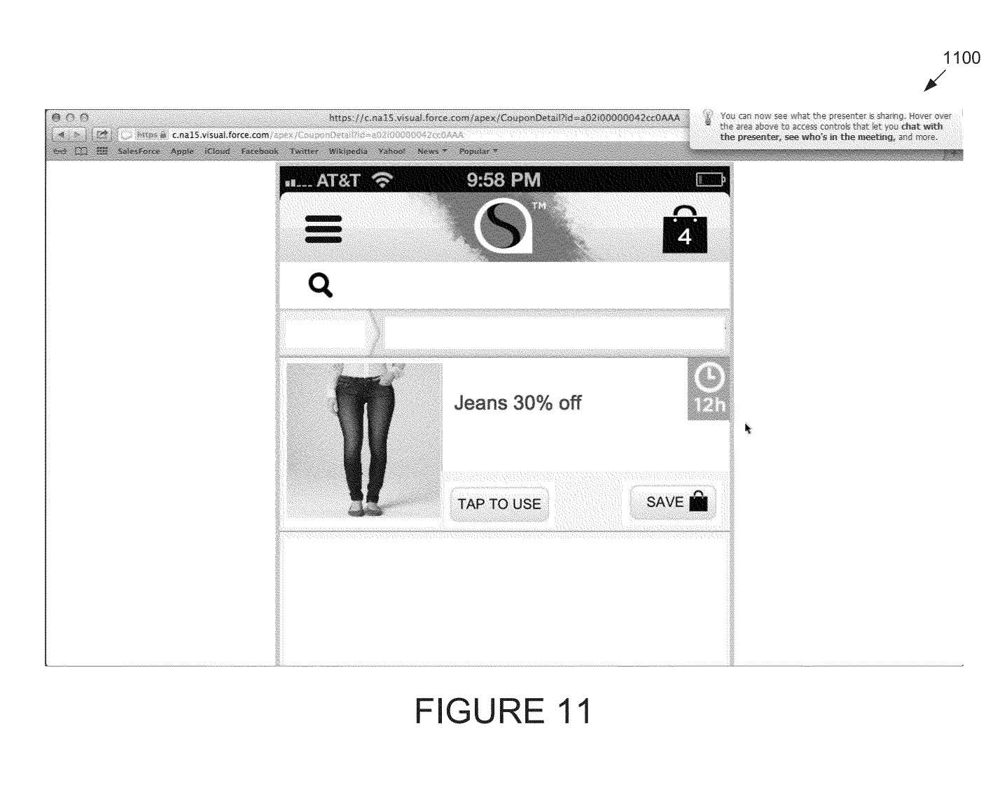

FIG. 11 depicts a preview screen 1100 of an exemplary promotion management application, according to some embodiments. A merchant may have been linked to the preview screen after clicking the “Save” button at the bottom of the promotion image upload screen 1000, shown in FIG. 10. The preview screen 1100 may depict how the promotion would appear on the customer device 110. The preview screen 1100 may appear in a container application, such as an Internet browser or a mobile device emulation environment. The preview screen 1100 may include: an image of the promotion, a description of a discount, a duration of the promotion, and a button (labeled “Tap to Use”) that emulates how a customer would obtain the promotion code associated with the promotion.

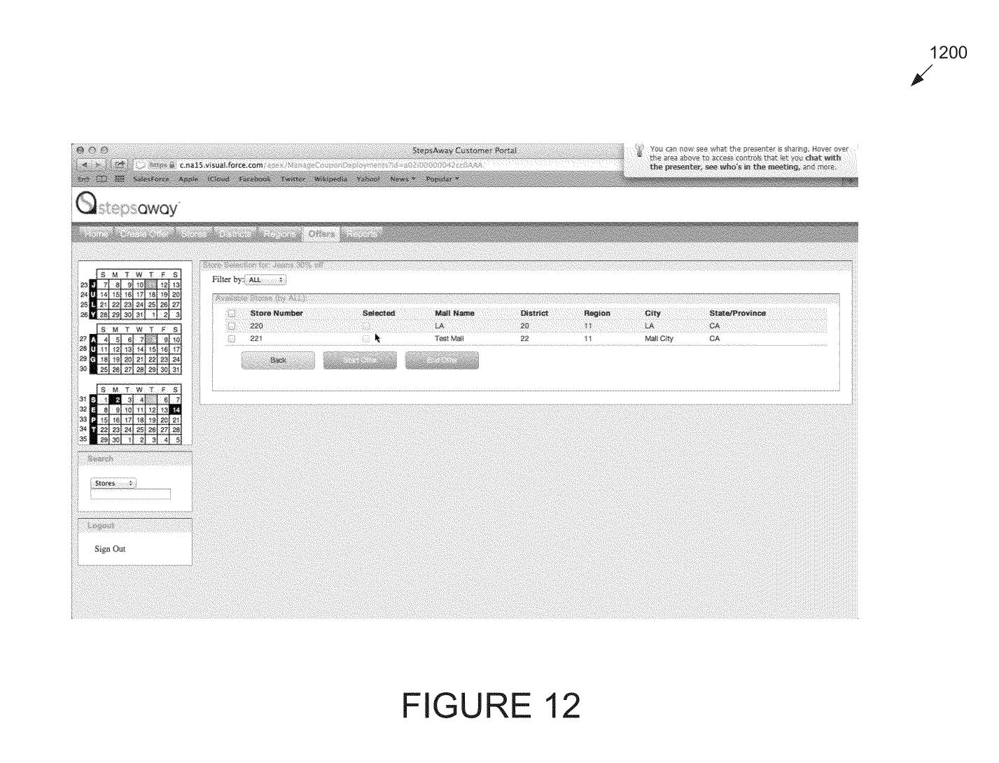

FIG. 12 depicts a deployment screen 1200 of an exemplary promotion management application, according to some embodiments. A merchant may have been linked to the deployment screen 1200 after closing the preview screen 1100. The deployment screen 1200 may include a deployment pane for the promotion being created. The deployment screen 1200 shows a listing of stores (stores numbered “220” and “221). The deployment screen 1200 further shows checkboxes allowing the merchant to select the stores to deploy the promotion to. The deployment screen 1200 may include a “Back” button that allows the merchant to further edit the offer. The deployment screen 1200 may further include a “Start Offer” button that allows the promotion to be pushed to the promotion management controller 135, and an “End Offer” button that allows the promotion to be purged from the promotion management controller 135.

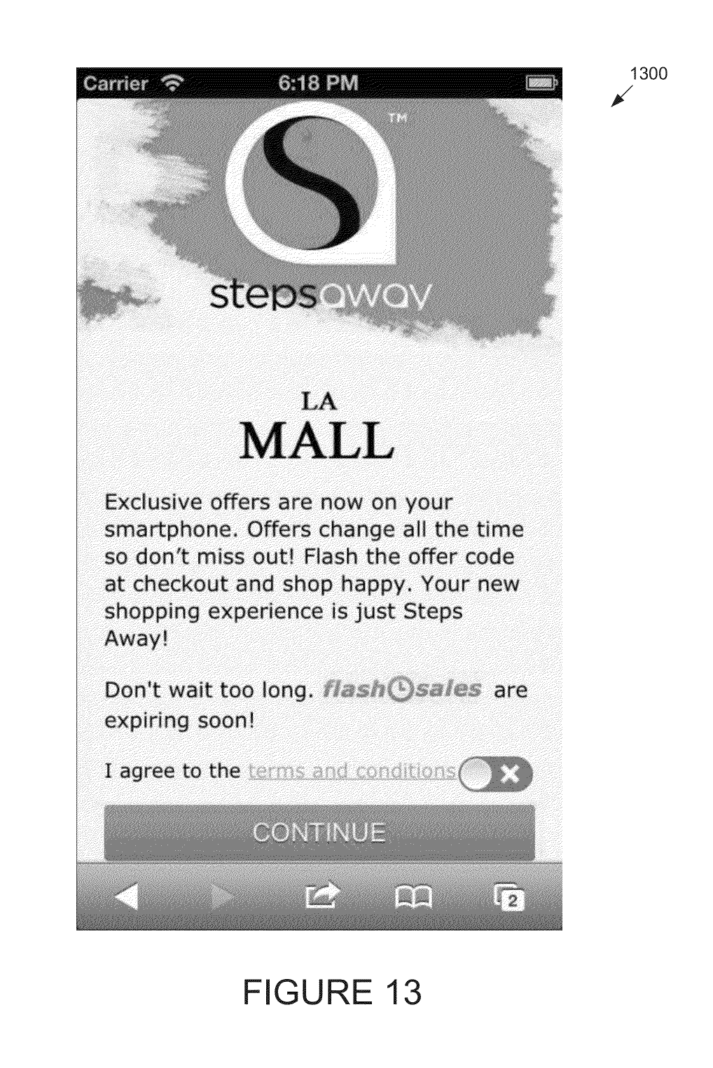

FIG. 13 depicts a network entry screen 1300 of an exemplary customer application, according to some embodiments. A customer may be taken to the network entry screen 1300 when the customer device 110 migrated to the network 120 through the network access point 115 or when the customer opened an Internet browser on the customer device 110. The network entry screen 1300 may have been displayed in an Internet browser or a mobile application. The network entry screen 1300 shows an application image (labeled “stepsaway,” a facility identifier (labeled “LA MALL”), a marketing pitch, a terms and conditions link, and a terms and conditions button. The application image, the facility identifier, and the marketing pitch may help identify the facility and the customer application. The terms and conditions link may list out the terms and conditions required for accessing the network 120. A customer's clicking of the terms and conditions button may indicate that the customer has agreed to the terms and conditions of access to the network 120.

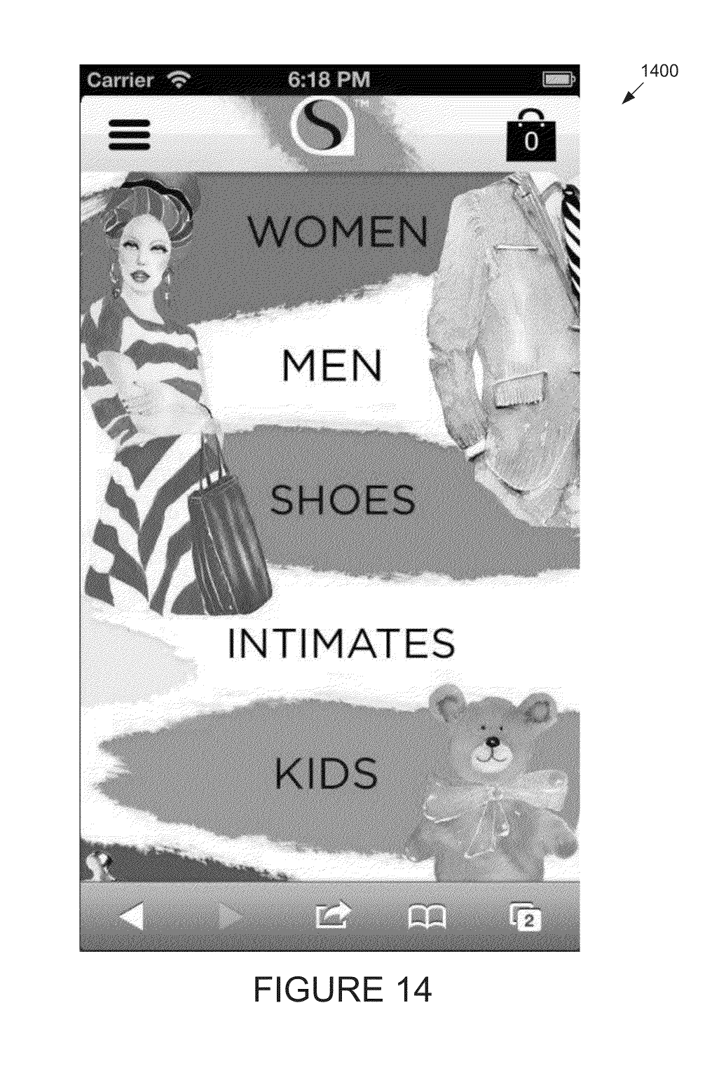

FIG. 14 depicts a promotions screen 1400 of an exemplary customer application, according to some embodiments. A customer may have been linked to the promotions screen 1400 by clicking the terms and conditions button at the bottom of the network entry screen 1300, shown in FIG. 13. The promotions screen 1400 shows various categories of items for which promotions are available in the facility that the customer is in. For example, the promotions screen 1400 may contain categories for: women, men, shoes, intimates, and kids.

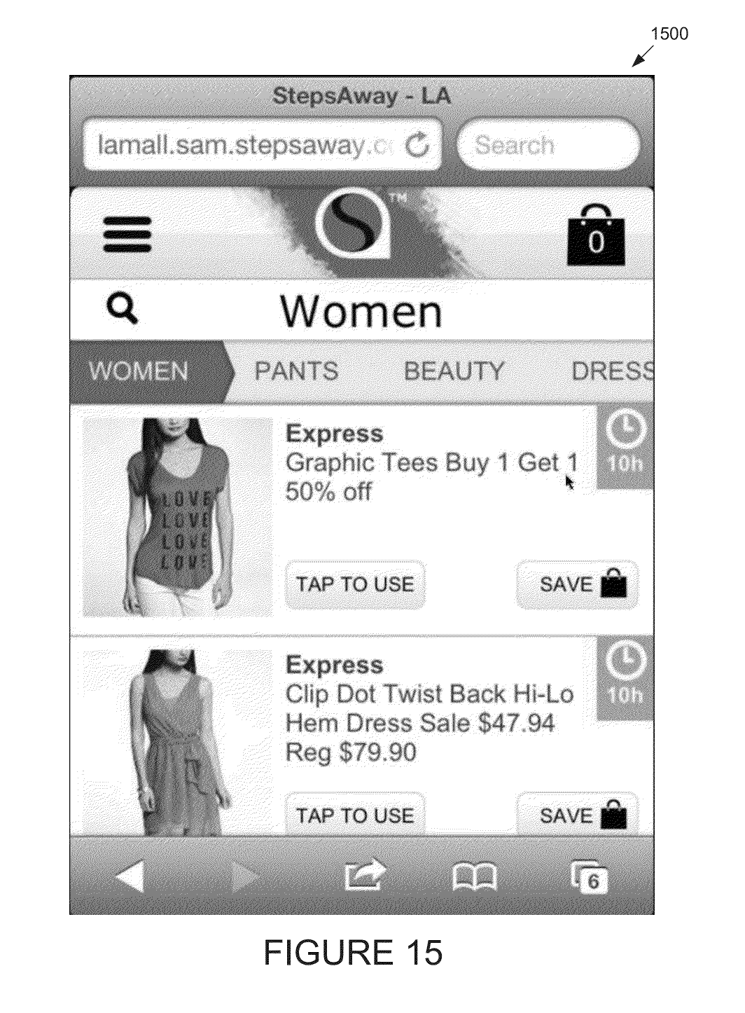

FIG. 15 depicts a promotions screen 1500 of an exemplary customer application, according to some embodiments. A customer may have been linked to the promotions screen 1500 by clicking on one of the categories in the promotions screen 1400, shown in FIG. 14. The promotions screen 1500 shows promotions related to women's clothing in a facility. More specifically, the promotions screen 1500 includes tabs for promotions on pants, beauty, and dresses. Each promotion may include relevant promotion content, a “Tap to Use” button to redeem the promotion, and, in the case of flash promotions, an indication of how long the promotion will last. The promotions screen 1500 may also include, at the top left-hand side, a settings button to list available promotions in ways other than by category (e.g., by store or by category).

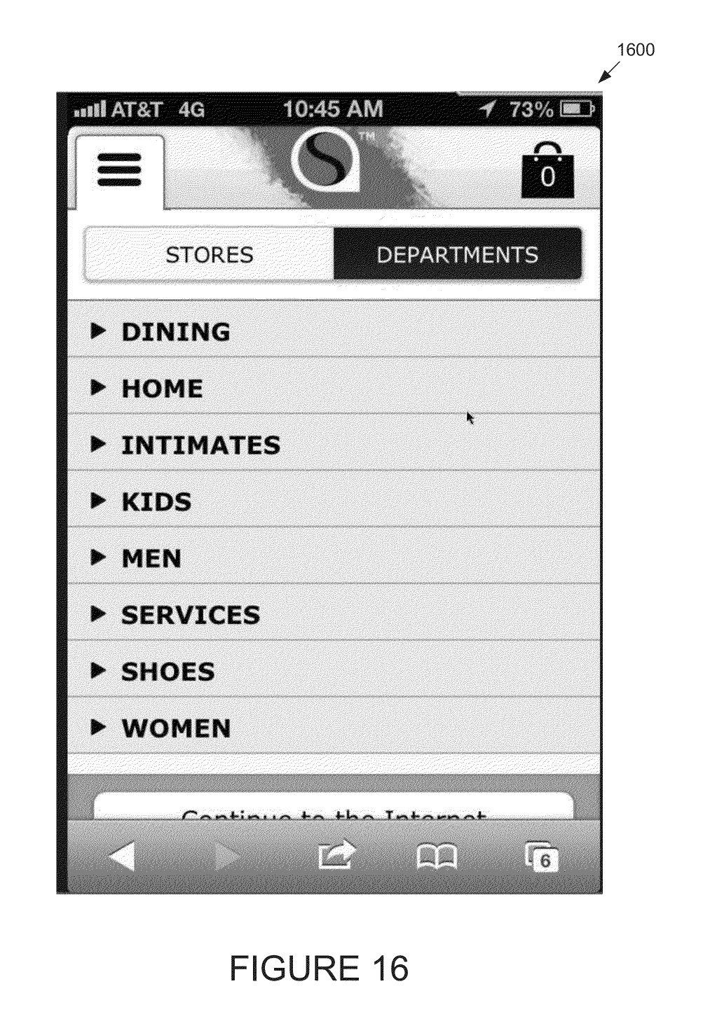

FIG. 16 depicts a department screen 1600 of an exemplary customer application, according to some embodiments. A customer may have been taken to the department screen 1600 by selecting the settings button at the top left-hand side of the promotions screen 1500. The department screen 1600 may include a listing of promotions by store departments.

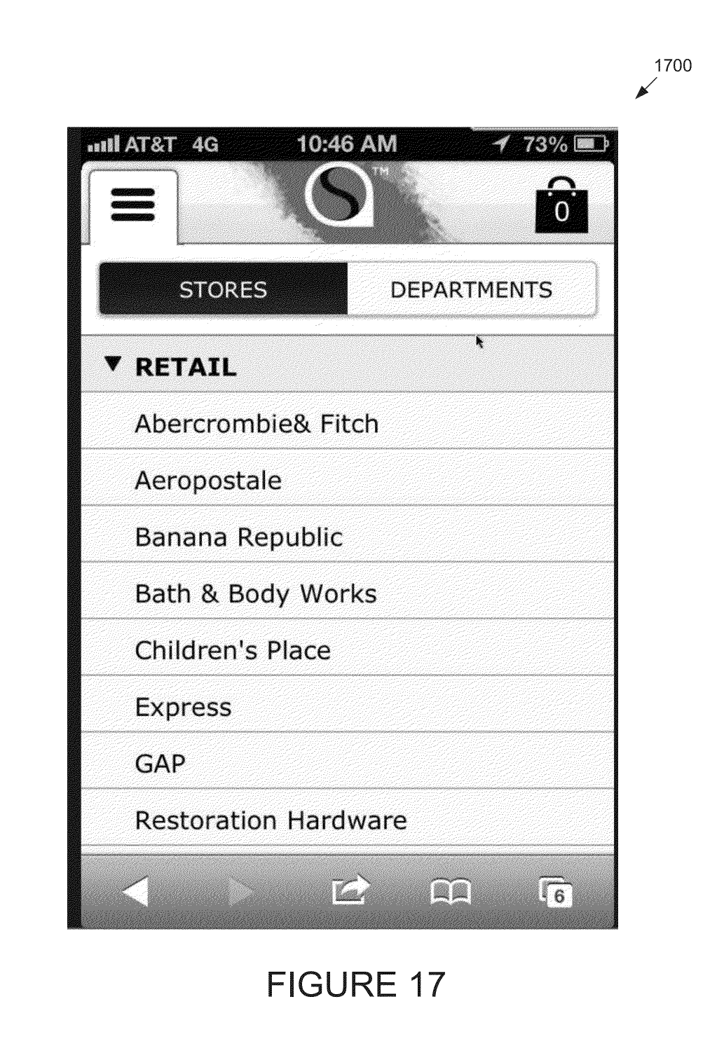

FIG. 17 depicts a merchant screen 1700 of an exemplary customer application, according to some embodiments. A customer may have been taken to the merchant screen 1700 by selecting the settings button at the top left-hand side of the promotions screen 1500 and/or the department screen 1600. The merchant screen 1700 may list promotions by the various merchants in a facility. Merchants shown in the merchant screen 1700 include: Abercrombie & Fitch®, Aeropostale®, Banana Republic®, Bath & Body Works®, Children's Place®, Express®, GAP®, and Restoration Hardware®. Selecting each of the merchants may take the customer to promotions related to that merchant.

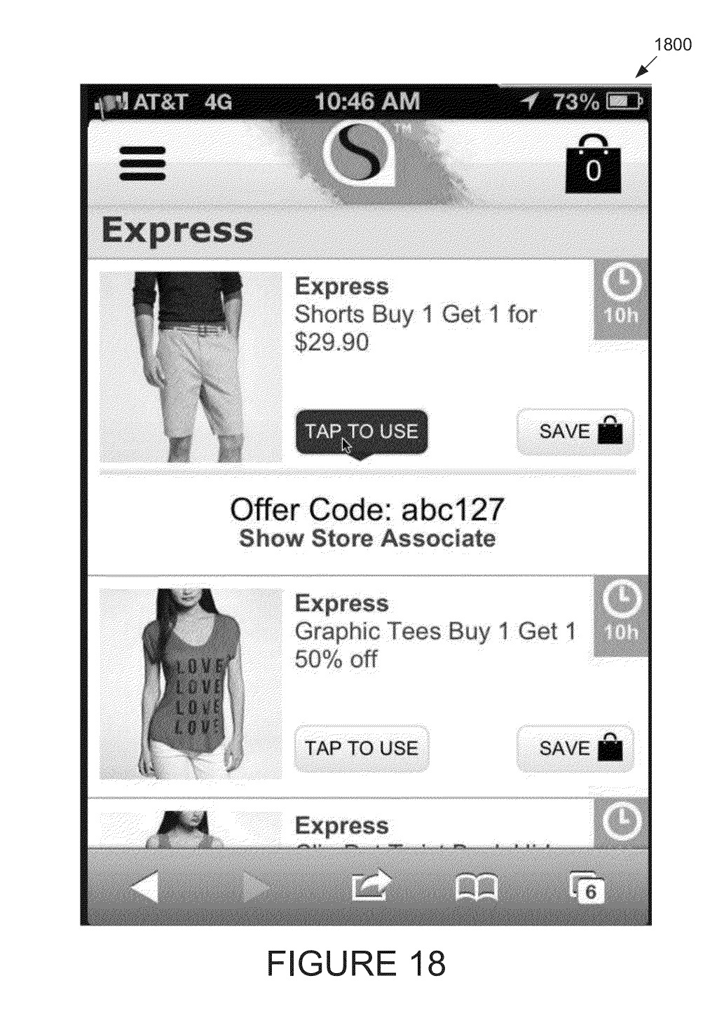

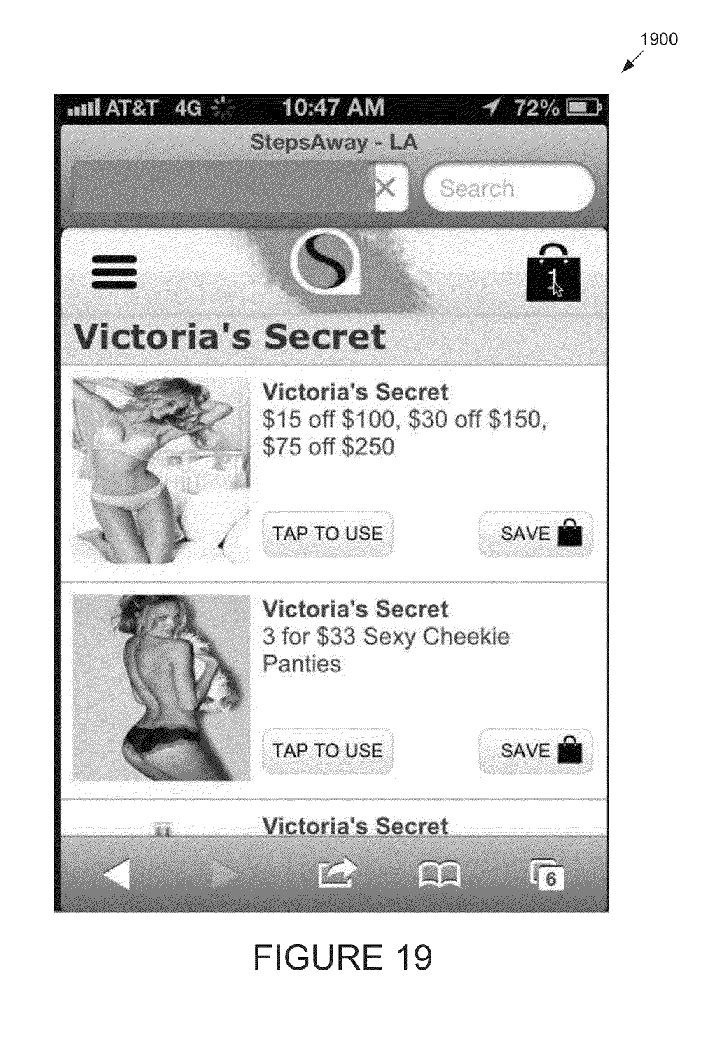

FIG. 18 depicts a particular merchant screen 1800 of an exemplary customer application, according to some embodiments. A customer may have been taken to the particular merchant screen 1800 after clicking on the “Express” link on the merchant screen 1700, shown in FIG. 17. Also shown in the particular merchant screen 1800 is an example of a promotion code that has been displayed upon clicking the “Tap to Use” button for the first promotion. As shown, the promotion code may include an alphanumeric code (“abc127”) and redemption instructions (“Show Store Associate”). FIG. 19 shows another particular merchant screen 1900 of an exemplary customer application, according to some embodiments. The particular merchant screen 1900 shows the promotions available for the merchant “Victoria's Secret”®.

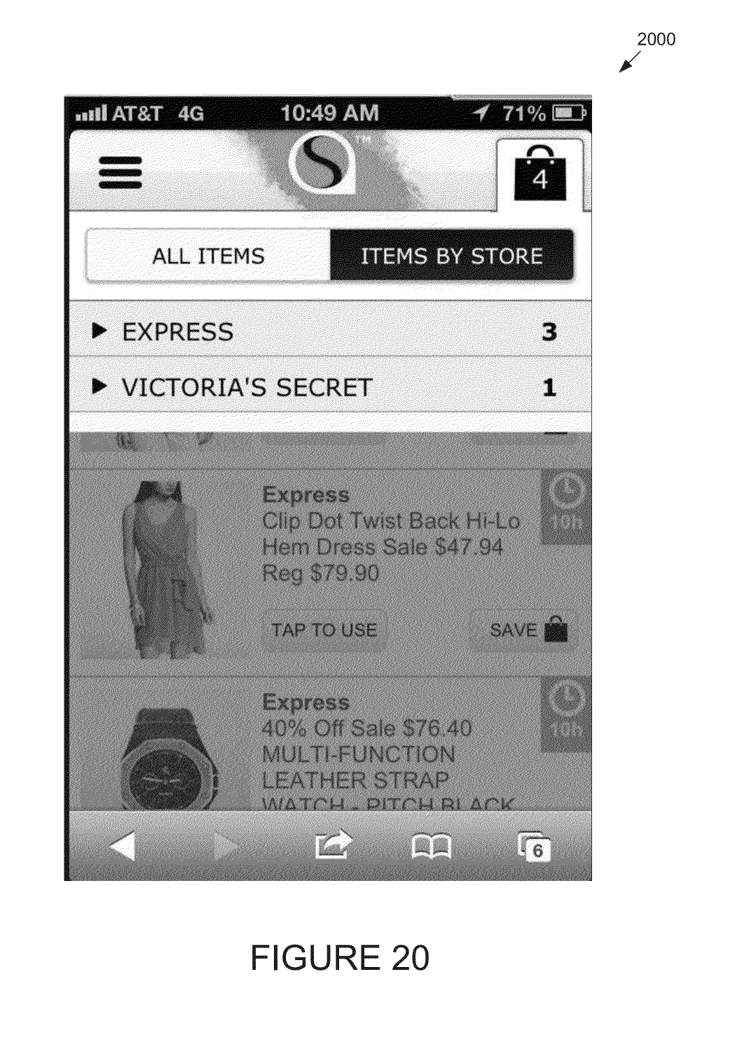

FIG. 20 depicts a selected promotion screen 2000 of an exemplary customer application, according to some embodiments. A customer may have been taken to the selected promotion screen 2000 upon selecting promotions at various locations in the customer application. The selected promotion screen 2000 may include a listing of promotions the customer has shown interest in using. In the selected promotion screen 2000, the customer has shown interest in using three promotions from the merchant “Express”® and one promotion from the merchant “Victoria's Secret.”®

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “some embodiments”, “various embodiments”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the embodiments is intended to be illustrative, but not limiting, of the scope, which is set forth in the following claims.

The use of names of or images associated with commercial entities, trademarks, trade names, trade dress, and/or other intellectual property provided in the examples herein are used for illustrative purposes. The use of such in this application does not imply that any entity associated with names, images, trademarks, trade names, trade dress, and/or other intellectual property are presently or will in the future be merchants or customers of, or otherwise affiliated with, any commercial or other embodiments of the inventive concepts described herein.

What is claimed is:

1. A method comprising:
receiving a request from a customer device to access a local area network, the local area network accessible via one or more network access points in a geographic location;
providing a network entry page to the customer device in response to the request, the network entry page providing a portal to a set of promotions offered by a set of merchants, the set of promotions being redeemable by a user of the customer device, the set of merchants being in the geographic location;
receiving a selection by the user of a particular promotion from the set of promotions; and
providing to the customer device a promotion code associated with the particular promotion, the promotion code enabling redemption of the particular promotion from a particular merchant.

2. The method of claim 1, wherein the particular merchant is located within the coverage of the local area network.

3. The method of claim 1, wherein the particular promotion comprises a timer configured to expire the particular promotion.

4. The method of claim 1, wherein the promotion code comprises an alphanumeric code or an image.

5. The method of claim 1, wherein the promotion code comprises a barcode or a Quick Response (QR) code.

6. The method of claim 1, wherein enabling the redemption of the promotion code comprises machine reading the promotion code.

7. The method of claim 1, further comprising monitoring whether the particular promotion was redeemed.

8. The method of claim 1, further comprising providing analytics related to the particular promotion.

9. The method of claim 1, further comprising providing analytics related to the customer device.

10. The method of claim 1, wherein the local area network comprises an 802.11 wireless network.

11. The method of claim 1, wherein the request to access the local area network is received in response to the customer device attempting to switch from another data network.

12. The method of claim 11, wherein the other data network comprises a Third Generation (3G) or a Fourth Generation (4G) data network.

13. The method of claim 1, wherein the network entry page is rendered on a web browser on the customer device.

14. The method of claim 1, wherein the network entry page comprises a home page of a mobile application on the customer device.

15. A system comprising:
a network monitoring module operative to receive a request from a customer device to access a local area network, the local area network accessible via one or more network access points in a geographic location;
a network entry page module operative to provide a network entry page to the customer device in response to the request, the network entry page providing a portal to a set of promotions offered by a set of merchants, the set of promotions being redeemable by a user of the customer device, the set of merchants being in the geographic location; and
a promotion control module operative to:
receive, a selection by the user of a particular promotion from the set of promotions, and
provide to the customer device a promotion code associated with the particular promotion, the promotion code enabling redemption of the particular promotion from a particular merchant.

16. The system of claim 15, wherein the particular promotion comprises a timer configured to expire the particular promotion.

17. The system of claim 15, further comprising a promotion search module operative to facilitate a search of the set of promotions.

18. The system of claim 15, further comprising a promotion sharing module operative to facilitate sharing of the set of promotions.

19. The system of claim 15, further comprising a customer profile management module operative to manage a customer profile of the customer device.

20. A system comprising:
means for receiving a request from a customer device to access a local area network, the local area network accessible via one or more network access points in a geographic location;
means for providing a network entry page to the customer device in response to the request, the network entry page providing a portal to a set of promotions offered by a set of merchants, the set of promotions being redeemable by a user of the customer device, the set of merchants being in the geographic location;
means for receiving a selection by the user of a particular promotion from the set of promotions, and for providing to the customer device a promotion code associated with the particular promotion, the promotion code enabling redemption of the particular promotion from a particular merchant.
